(19) United States
(12) Patent Application Publication
(10) Pub. No.: US 2021/0287149 A1
(43) Pub. Date: Sep. 16, 2021

(54) EFFICIENTLY ACCESSING AND VISUALIZING SUPPLY CHAIN DATA

(71) Applicant: 3M Innovative Properties Company, St. Paul, MN (US)

(72) Inventors: Viruru Phaniraj, Woodbury, MN (US); Karl W. Bloedorn, Menlo Park, CA (US); Samuel J. Anderson, Roseville, MN (US); Michael J. Lovell, Stillwater, MN (US); Peter A. Hockey, Menlo Park, CA (US); Jennifer L. Austin, Lino Lakes, MN (US); Jeffrey L. Ranch, Woodbury, MN (US); Andrew J. Pung, Stillwater, MN (US); David C. Borchard, Inver Grove Heights, MN (US); Donald S.D. Hart, II, Minneapolis, MN (US); Jim D. Jacob, Cottage Grove, MN (US); Kirk R. Soule, Stanton, MN (US); Matthew J. Siemer, Cottage Grove, MN (US); Scott R. Jilek, Minnetonka, MN (US)

(21) Appl. No.: 16/818,424

(22) Filed: Mar. 13, 2020

(51) Int. Cl. G06Q 10/06; G06Q 50/28; G06F 3/0484

(52) U.S. Cl. CPC G06Q 10/067; G06F 3/04842; G06Q 50/28

(57) ABSTRACT

Systems, methods, and devices for accessing and visualizing supply chain data. A computing system can receive an indication of a selected facility item. The selected facility item can represent a particular supply chain item that is processed at a particular facility of a set of facilities in an organization. The system can render a first view of a user interface pertaining to the selected facility item. The computing system can receive a selection of a first user interface element within the first view of the user interface, and in response, transition from the first view of the user interface that includes the item flow map to a second view of the user interface that shows additional information pertaining to the selected facility item or the particular facility represented by the selected facility item that is not shown in the first view.

### BACKGROUND

Supply chain management is a critical task for many businesses and other organizations that depend on the flow of goods and services between distant locations. Considering the global scale of the modern economy, supply chains often extend across vast geographic areas, and can implicate flows of large numbers of goods and services. Individual facilities such as plants or warehouses that process (e.g., manufacture, store, or distribute) goods and services in a supply chain often maintain detailed records concerning the facility's local processing of such items. However, business leaders and other stakeholders may have need to review supply chain data across facilities in the organization, and may further have need to review supply chain data aggregated from multiple facilities. Due to factors such as the volume of information available, differences in supply chain management systems employed at different facilities, and non-standardized metrics employed at each facility, it can be difficult for users to quickly and efficiently access relevant data to gather desired insights. For example, some supply chain management software require users to click through many screens to access relevant data about items processed at various facilities in the supply chain.

### SUMMARY

This specification describes systems, methods, devices, and other techniques for efficiently accessing and visualizing supply chain data. A supply chain management system can be configured to render a user interface in a native application or web application at a client device. The interface is arranged to allow a user to select a “facility item,” i.e., an object representing a particular item (e.g., a raw material, a component of a manufactured good, a semi-finished good, or a finished good) that is processed at a particular facility in a supply chain. Upon the user's selection of the facility item, the system can bring up a new view of the user interface pertaining to the selected facility item. The user interface can initially launch in a first view that presents a first mode of information about the facility item, but includes controls that enable a user to quickly transition to other views that present alternate modes of information about the facility item. For instance, the first view may be a geographical-based view having an item flow map that shows flows of the item from a first facility to one or more upstream or downstream facilities in the supply chain. Other views may show more detailed or data-rich information about the facility item, such as trends in the facility's processing of the item over time. Moreover, users can quickly jump to views of user interfaces pertaining to upstream or downstream facilities, including the upstream/downstream facility's processing of the same item represented by the user's initial selection of a facility item. As another example, the system may render a user interface at the client device that visually indicates values of one or more metrics such as inventory levels or on-time and in-full order fulfilment (OTIF) for a set of facilities in a supply chain. These and other techniques can provide an improved experience that allow users to quickly access and visualize relevant information about a supply chain. Users can filter potentially vast amounts of information to isolate specific information of interest, and then interact with readily-accessible controls in a user interface to switch between views corresponding to different modes of information about a selected item. Likewise, a user may quickly navigate to information about related facilities in the supply chain without needing to separately traverse a multitude of screens outside the context of a currently accessed facility.

Implementations of the subject matter described herein include computer-implemented methods, and the methods can be carried out by a system of one or more computers in one or more locations. For example, a computing system can receive an indication of a selected facility item. The selected facility item can represent a particular supply chain item that is processed at a particular facility of a set of facilities in an organization. The system can render, for display on a screen of the computing system, a first view of a user interface pertaining to the selected facility item. The first view of the user interface can include an item flow map that shows a flow of the particular supply chain item represented by the selected facility item between at least two facilities including the particular facility represented by the selected facility item. The computing system can receive a selection of a first user interface element within the first view of the user interface, and in response, transition from the first view of the user interface that includes the item flow map to a second view of the user interface that shows additional information pertaining to the selected facility item or the particular facility represented by the selected facility item that is not shown in the first view.

These and other implementations can further include none, one, or more of the following features.

Receiving the indication of the selected facility item can include receiving (i) an item identifier that uniquely represents the particular supply chain item and (ii) a facility identifier that uniquely represents the particular facility.

The first user interface element can be a button that is available for selection by a user in both the first and second views of the user interface.

Transitioning from the first view of the user interface to the second view of the user interface can include replacing a display of the item flow map with at least one other user interface element so that the item flow map is no longer displayed in the user interface. The at least one other user interface element can show the additional information pertaining to the selected facility item or the particular facility represented by the selected facility item.

Transitioning from the first view of the user interface to the second view of the user interface can include transitioning to a view that shows additional information pertaining to the selected facility item that is not show in the first view. The additional information can include values of one or more metrics related to the particular facility's processing of the particular supply chain item. The one or more metrics related to the particular facility's processing of the particular supply chain item can be selected from a group that includes a monetary value of inventory of the particular supply chain item at the particular facility, a quantity of the particular supply chain item at the particular facility, a target level of inventory of the particular supply chain item at the particular facility, a level of backorders of the particular supply chain item at the particular facility, and a percentage of on-time and in-full (OTIF) deliveries of the particular supply chain item made from the particular facility.

Transitioning from the first view of the user interface to the second view of the user interface can include bringing up a plot showing values of one or more metrics related to the particular facility's processing of the particular supply chain item over an interval of time.

The computing system can receive, within the second view of the user interface, a selection of the first user interface element or a second user interface element, and in response, transition from the second view of the user interface to the first view of the user interface that includes the item flow map.

The computing system can receive, within the first view of the user interface or within the second view of the user interface, a selection of a second user interface element, and in response, transition from (i) the first view of the user interface pertaining to the selected facility item, or (ii) the second view of the user interface pertaining to the selected facility item or the particular facility represented by the selected facility item, to a third view of the user interface pertaining to a second facility's processing of the particular supply chain item represented by the selected facility item. The second facility can be an upstream facility that supplies the particular supply chain item to the particular facility or a downstream facility is supplied the particular supply chain item from the particular facility.

Rendering the first view of the user interface can include collecting data for the item flow map. Collecting the data for the item flow map can include actions of identifying the particular facility represented by the selected facility item; identifying a second facility upstream of the particular facility that supplies the particular supply chain item to the particular facility; identifying one or more third facilities other than the particular facility that are located downstream of the second facility such that the second facility supplies the one or more third facilities with the particular supply chain item; and rendering visual markers on the item flow map corresponding to the particular facility, the second facility, and the one or more third facilities.

The particular facility represented by the selected facility item can initially have focus in the first view of the user interface. While the particular facility has focus, the computing system can receive a selection of a second user interface element within a view of the user interface that pertains to the selected facility item. In response to receiving the selection of the second user interface element, the system can shift focus from the particular facility to a second facility based on the second facility being upstream or downstream of the particular facility with respect to the particular supply chain item. The system can receive a selection of the first user interface element or a third user interface element while the second facility has focus within the view of the user interface that pertains to the selected facility item. In response to receiving the selection of the first user interface element or the third user interface element while the second facility has focus within the view of the user interface that pertains to the selected facility item, the system can transition from the view of the user interface that pertains to the selected facility item to a view of the user interface that pertains to the second facility. The view of the user interface that pertains to the second facility can be a view that pertains to the second facility's processing of the particular supply chain item. The view of the user interface that pertains to the selected facility item can be the first view of the user interface or the second view of the user interface. The second user interface element can be a visual marker on the item flow map representing the second facility. The second user interface element can be a control that is not specifically associated with any particular facility.

The user interface can be rendered in and by a web browser application installed on the computing system.

The item flow map can include a background map of a geographic region and a set of visual markers overlaid on the background map. The set of visual markers can include a first visual marker for the particular facility represented by the selected facility item, one or more second visual markers for one or more other facilities in the organization that also process the particular supply chain item represented by the selected facility item, and one or more third visual markers depicting the flow between the at least two facilities.

Additional aspects of the techniques described in this specification include a computing system configured to carry out the actions and methods disclosed herein. The computing system can include one or more processors (e.g., processing devices) and one or more computer-readable media. The computer-readable media (e.g., non-transitory media) can have instructions stored thereon that, when executed by the one or more processors, cause the one or more processors to perform any of the actions and methods disclosed in this specification. In yet a further aspect, the one or more computer-readable media can be made available apart from the system, and encoded with instructions that, when executed by one or more processors, cause the one or more processors to perform any of the actions and methods disclosed in this specification.

The details of particular implementations of the subject matter described in this specification are set forth in the accompanying drawings and the description below. Other features, aspects, and advantages of the subject matter will be apparent from the description, the drawings, and the claims.

### BRIEF DESCRIPTION OF DRAWINGS

FIG. 1 is a block diagram of an example computing system for processing and presenting supply chain data from a group of facilities.

FIG. 2 is a flowchart of an example process for efficiently transitioning between views of a user interface using an item flow map.

FIGS. 3A-3D depict screenshots of example interactions with a user interface including an item flow map.

FIGS. 4A-4E depict screenshots of an example user interface showing representations of facilities in a supply chain.

FIG. 5 is a flowchart of an example process for rendering and interacting with a map displaying representations of facilities in a supply chain.

FIG. 6 is a schematic diagram of a computing system having components usable to implement aspects of the computer-implemented methods and other techniques described herein.

### DETAILED DESCRIPTION

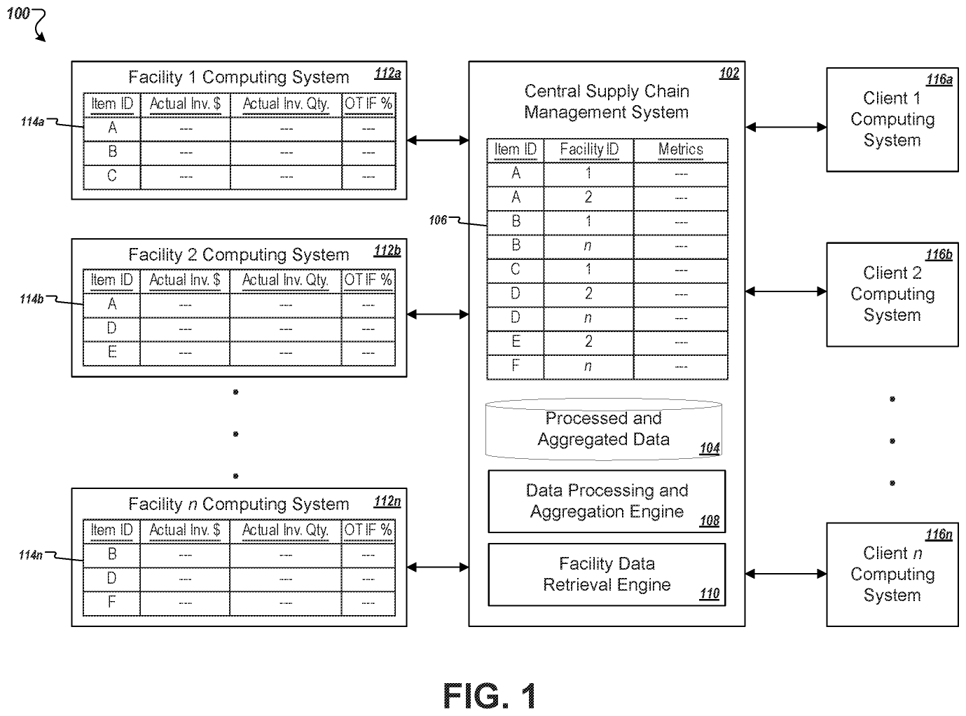

Referring to FIG. 1, a block diagram is shown of an example computing system 100 configured to process and present supply chain data. The computing system 100 includes a central supply chain management system 102, one or more facility computing systems 112a-n, and one or more client computing systems 116a-n. As shown, client computing systems 116a-n are operable to connect and communicate over one or more networks (e.g., a local area network, wide area network, a mobile network, the Internet) with central system 102. Likewise, central system 102 is operable to connect and communicate over one or more networks (e.g., a local area network, wide area network, a mobile network, the Internet) with facility systems 112a-n. In some implementations, system 100 employs a client-server model in which central system 102 is configured as a server that responds to requests from client computing systems 116a-n and facility systems 112a-n, although other forms of communication (e.g., push systems) are also contemplated.

System 100 can be maintained and operated by or on behalf of a business, enterprise, or other organization that produces, distributes, stores, or otherwise processes items in a supply chain. In the course of maintaining the supply chain, the organization may operate or partner with various facilities at disparate geographic locations. For example, the facilities may include manufacturing plants that process raw materials and produce finished or semi-finished goods, distribution centers and warehouses that store goods ready for distribution in a local geographic region, retailers that shelve finished goods for sale to the ultimate customer, supplier facilities that furnish to the organization items used in a manufacturing or production process, or a combination of these. Typically, each facility in the supply chain maintains electronic records related to operation of the facility. The records may be maintained in enterprise resource planning (ERP) software, relational databases, spreadsheets, customized facility-specific software, supply chain management systems, or any other type of software platform, data storage repository, or combination of these. A warehouse, for instance, may maintain records describing inventory levels (e.g., quantities) of each type of item (e.g., each stock-keeping unit (“SKU”)) currently stored in the warehouse, records describing expected deliveries of various items to and from the warehouse over upcoming periods of time, and records describing historical inventory levels in the warehouse. A manufacturing plant may maintain records of raw material levels used in manufacturing a finished good, planned production levels, actual production levels, and inventory levels of semi-finished or finished goods. Other facilities may maintain similar records corresponding to the respective function of the facility.

Facility systems 112a-n are the computing systems that manage and maintain records pertaining to operations of the facility. Each facility system 112a-n represents a computing system that manages and maintains operational records for a different facility of the supply chain. For instance, facility system 112a may correspond to a supplier's facility, facility system 112b may correspond to a manufacturing facility, and facility system 112n may correspond to a distribution center. While only three facility systems are expressly shown in FIG. 1, it should be understood that the system 100 may encompass many facility systems, e.g., tens, hundreds, or even thousands of facilities for larger organizations. Each facility system 112a-n may be implemented on one or more computers at one or more locations. In some cases, a facility system may be physically located on the premises of the facility itself, although other arrangements are possible. In some implementations, a same set of one or more computers may manage and maintain records on behalf of multiple facilities, in which case the facility system for each facility may correspond to the logical portion of the set of computers that manages and maintains records on behalf of the individual facility.

Central system 102 includes one or more computers in one or more locations and is configured to process data received from each of the facility systems 112a-n. One object of central system 102 is to make data from across the facilities in a supply chain readily available to client computing systems 116a-n in a standardized or universal format. For example, central system 102 may include a facility data retrieval engine 110 that manages retrieval of data from facility systems 112a-n. Retrieval engine 110 ensures that central system 102 accesses current data from each facility on a continuous, periodic, or otherwise regular basis. In some implementations, retrieval engine 110 maintains continuous connections with each facility system 112a-n, and updates to local facility data at each of the facility systems 112a-n is automatically pushed to the central system 102 over the continuous connection in real-time. In some implementations, retrieval engine 110 may initiate connections to the facility systems 112a-n according to a schedule (e.g., every hour, every 12 hours, every 24 hours, or every 48 hours) and obtain the latest facility data from the facility on request during these scheduled sessions. Additionally or alternatively, facility systems 112a-n may push updated facility data to the central system 102 on a scheduled or regular basis, or otherwise upon the occurrence of certain triggering events.

Central system 102 further includes a data processing and aggregation engine 108. The data processing and aggregation engine 108 processes initial data received from individual facility systems 112a-n to generate actionable data that is suitable for provision to and consumption by client computing systems 116a-n. In some implementations, generation of actionable data includes re-formatting data received from the individual facility systems 112a-n into a common or universal format. In many cases, different facilities may use different software platforms and different record keeping conventions and practices than those employed by other facilities. The data processing and aggregation data processing and aggregation 108 can resolve differences in data formats stemming from these variations in local recordkeeping practices. Data processing and aggregation data processing and aggregation 108 can also perform data aggregation and consolidation operations to determine values of supply chain metrics that are not directly computed by the individual facility systems 112a-n. For example, facility systems 112a-n may each maintain individual data sets 114a-n that indicate, for each item (e.g., SKU) processed at the corresponding facility, actual inventory levels of the item (in dollars and quantity) and percentage of on-time and in-full (OTIF) deliveries (or order fulfilment) for each item. Some items may be processed only at a particular facility to the exclusion of other facilities (e.g., items C, E, and F), while other items are processed at multiple facilities (e.g., items A, B, and D).

As shown in table 106, data processing and aggregation data processing and aggregation 108 may consolidate information received from individual facilities into a merged data set that includes records for each “facility item” in the supply chain. A facility item is an object that represents a particular facility's processing of a particular item in a supply chain. The same item processed by two different facilities (e.g., item A and facilities 1 and 2) can be represented as two different facility items, for example. The central system 102 manages records for each facility item in the supply chain. For instance, as further shown in table 106, central system 102 maintains metadata for each facility item such as values of one or more supply chain metrics, e.g., actual inventory levels, OTIF, backorder amounts, target inventory levels, sales amounts, delivery projections, demand forecasts, etc. Data processing and aggregation data processing and aggregation 108 may also be configured to automatically pre-aggregate metadata (e.g., values of supply chain metrics) for groups of two or more facility items. For example, data processing and aggregation 108 may aggregate the metadata associated with all or a subset of items processed by an individual facility to derive facility-wide metrics. Additionally, data processing and aggregation 108 may aggregate the metadata associated with all or a subset of facilities that process a particular item or a particular group of items to derive overall item metrics for individual items or groups of items across facilities. In some implementations, data processing and aggregation 108 is programmed to automatically compute aggregated metrics on a regular or scheduled basis for a set of most popular groups of facility items that are frequently accessed by client computing systems 116a-n. Additionally, individual client computing systems 116a-n and users of the client computing systems 116a-n may request aggregation of metadata for additional groups of facility items on either a one-time or recurring (e.g., regular/periodic/scheduled) basis. Actionable data that is made accessible to client computing systems 116a-n, including re-formatted, merged, and aggregated data, can be stored in volatile and/or non-volatile memory in one or more data structures (e.g., databases) of a data repository 104. Central system 102 may expose an application programming interface (API) to client computing systems 116a-n allowing client computing systems 116a-n to access data from repository 104 as needed.

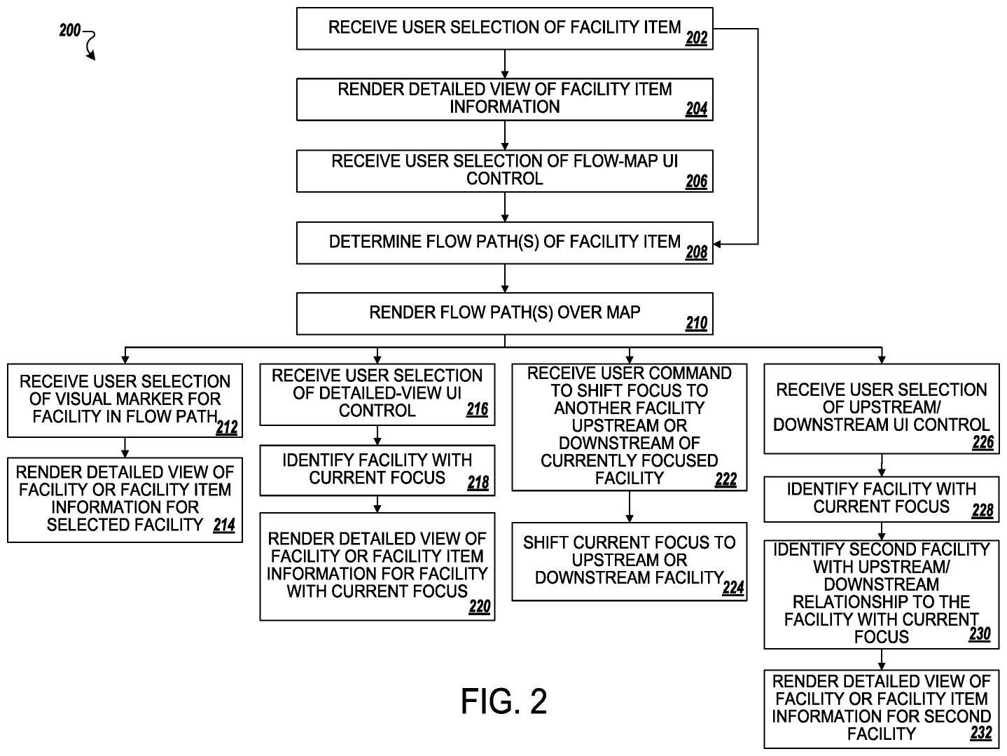

Client computing systems 116a-n allow end users to access and review supply chain data made available from central system 102. Although not shown in FIG. 1, in some implementations, client computing systems 116a-n may access supply chain data from sources other than or in addition to central system 102. For instance, some client computing systems 116a-n may obtain data directly from individual facility systems 112a-n. A client computer can be a desktop computer, notebook computer, tablet computer, smartphone, or any other suitably equipped user device. A client computing system can include processing and storage capabilities, a display, and input devices that allow the device to receive user inputs (e.g., keyboards, mouse, camera, microphone, touch sensors). Client computing systems 116a-n can further include software that allows user interfaces to be rendered for presentation (e.g., display) to a user of the device, such as the user interfaces described with respect to FIGS. 2-5. In some implementations, the client computing systems 116a-n include native applications for rendering the user interfaces, e.g., applications that are dedicated to supply chain management. In other implementations, the client computing systems 116a-n may access web applications that render the user interfaces through a web browser.

Referring now to FIG. 2, a flowchart is shown of an example process 200 for efficiently accessing and visualizing supply chain data at a client device. Process 200 can be performed by the front-end of a supply chain management system, e.g., system 100 of FIG. 1. In some implementations, process 200 is performed by a client device of an end user, e.g., any of client computing systems 116a-n of FIG. 1. In general, process 200 can allow a user to quickly glean key insights on historical, current, and/or projected aspects of a supply chain. Compared to traditional approaches that could require the user to click through many screens to access relevant and related data sets, process 200 implicates a user interface that allows the user to access such data more quickly and with minimal effort. These and other advantages of the techniques described with respect to FIG. 2 will be appreciated by those of ordinary skill in the art.

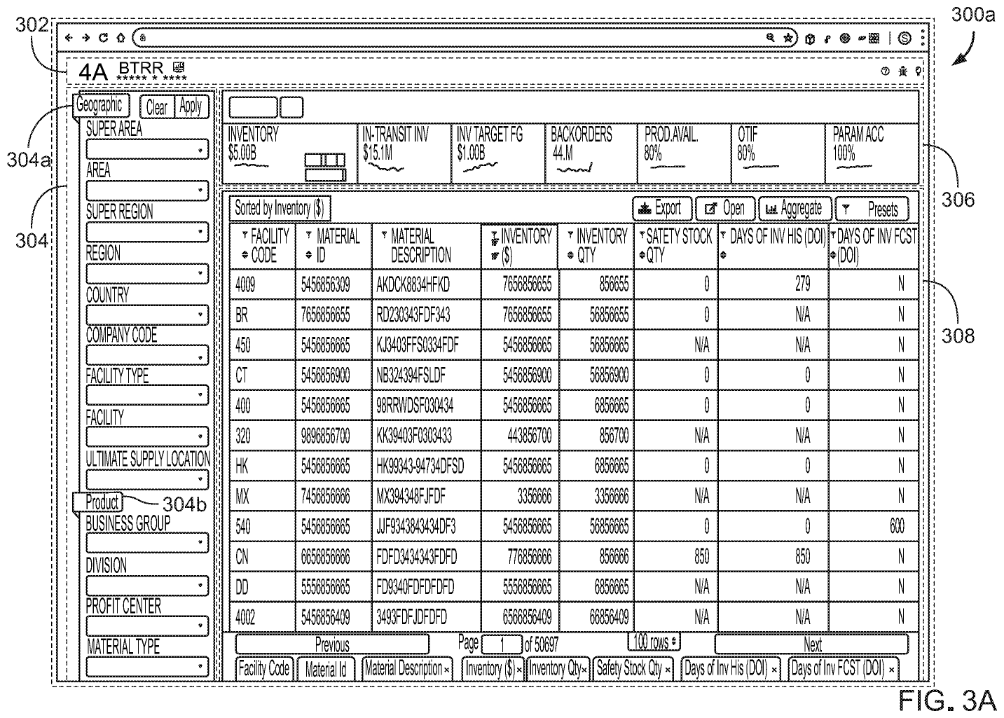

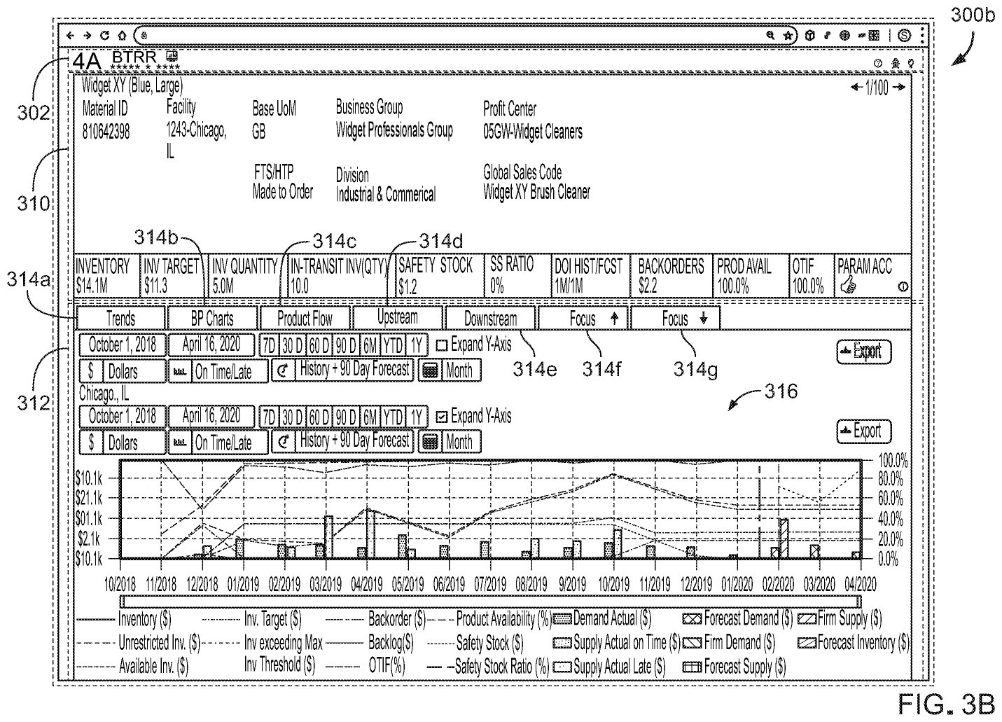

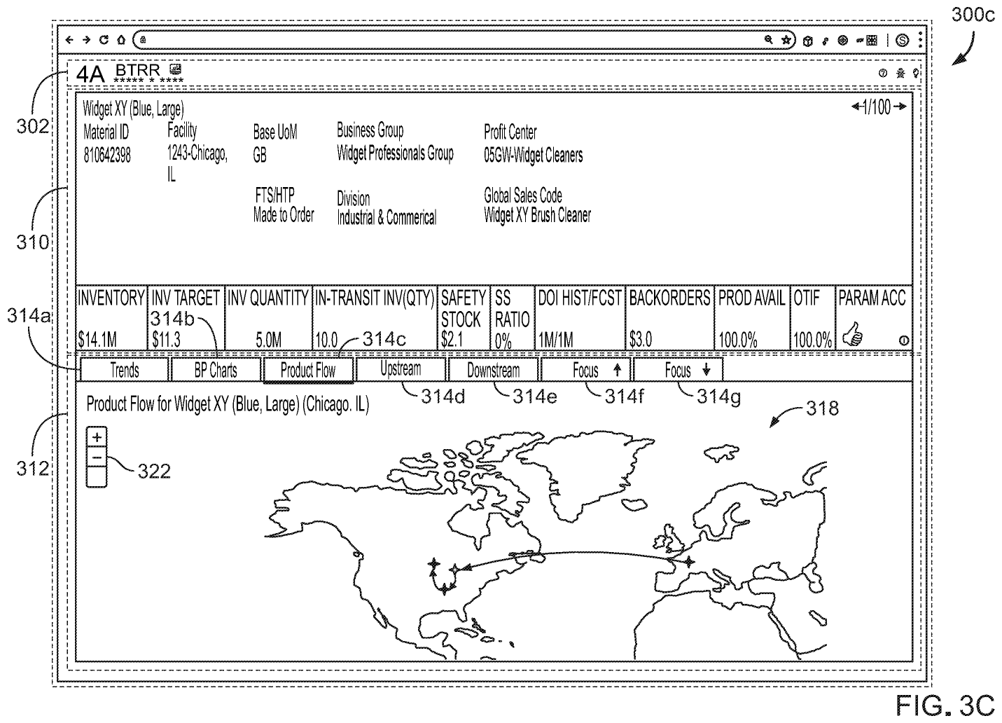

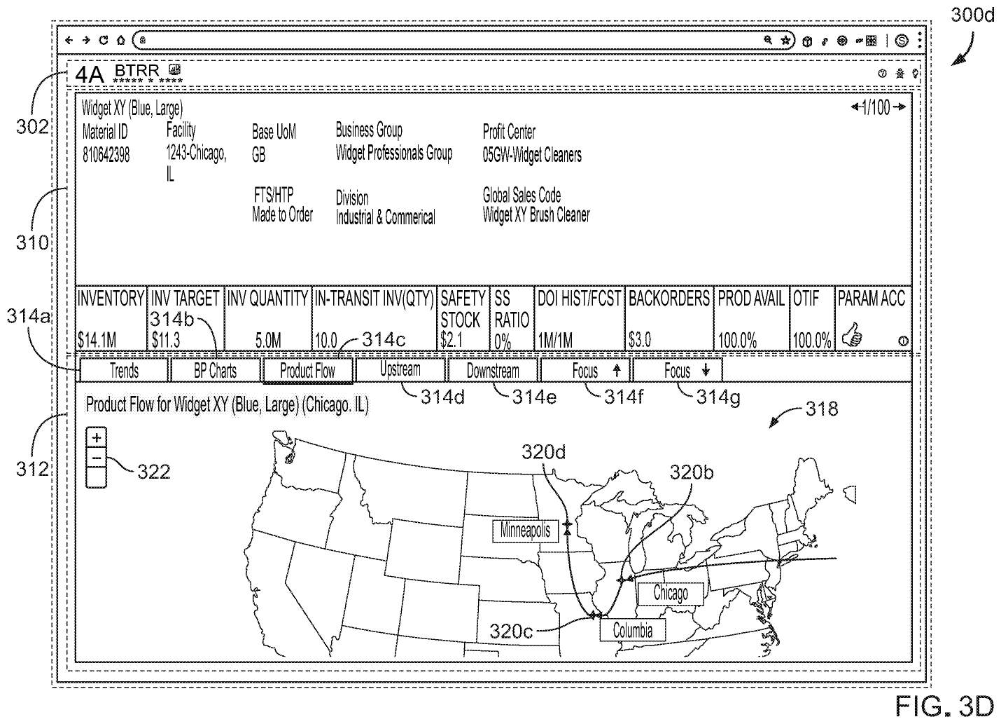

Process 200 can begin with a user's selection of a facility item (202). The facility item can be selected in a user interface presented on a screen of a client device, e.g., any of client computing systems 116a-n. The user interface may be presented by a native application installed on the client device, a web application accessed through a web browser on the client device, or by other suitable software on the device. In some implementations, the user selects the facility item from a filtered list of facility items, which can be presented to the user upon accessing the application, responsive to a search query submitted by the user for facility items that match specified search criteria, or responsive to a user's selection to filter a universe of facility items to generate a filtered set of facility items. For example, FIG. 3A depicts a screenshot of a view 300A of a user interface from which a user can select a facility item. The view 300A of the user interface can be rendered by an application at a client device, and may include various user interface elements that either present information to a user, provide a control with which the user can interact to trigger an action in the user interface, or both. View 300A includes several display regions 302, 304, 306, and 308 within a single window of the user interface. Display region 302 can include header information that sets context for the user interface, such as a logo for the organization that maintains the software platform and/or manages the supply chain. Display region 302 can also provide user interface elements (e.g., buttons) that are universally accessible from a range of views of the user interface, regardless of where the user is currently located in the application. These global controls can include a help button, settings button, account button, or others, which can be selected to access help, settings, account information, or other information that may be desired by a user.

Display region 304 provides controls that allow a user to search and/or filter facility items registered in the supply chain management system. In some implementations, display region 304 includes a first set of user interface elements 304a that allow a user to search/filter facility items based on geographic criteria. As shown, the geographic criteria can include a super area, a (minor) area, a super region, a (minor) region, a country, a company code, a facility type, a facility name or identifier, an ultimate supply location, or a combination of all or some of these. The geographic search/filtering criteria may allow the user to restrict identification of facility items to those items that are processed at facilities that match the specified geographic criteria. Display region 304 can also include a second set of user interface elements 304b that allow a user to search/filter facility items based on product attributes, such as the business group of the target product(s), business division of the target product(s), profit center of the target product(s), and material type of the target product(s). For example, a large industrial conglomerate may manufacture and distribute products ranging from chemicals to appliances to medical devices. Product searching/filtering may allow the user to restrict identification of facility items to those within specific sectors, business groups, or profit centers. In some implementations, the user can interact with the user interface elements in display region 304 by typing search/filtering criteria into the text boxes, and then select a button or other control to issue a search/filtering command. The client application can submit the search/filtering command to a server, e.g., central system 102, and then receive a response from the server containing a list of facility items matching the specified criteria, along with relevant metadata for the returned facility items. In further implementations, the details of the second set of user interface elements 304b may be pre-selected for a user, based upon the user's job responsibilities. In this way, the system may provide some inherent security, wherein users are allowed access to certain data based upon their role in an organization.

Display region 308 provides a table listing each facility item identified in response to the user's search/filtering query. Each table row lists a different facility item, and a user can scroll through the list to select individual rows or a group of multiple rows. Table columns correspond to attributes of the facility items. The attributes can include a unique identifier of the facility represented by the facility item, a unique identifier of the supply chain item (e.g., product or material) represented by the facility item, and metrics related to the facility's processing of the facility item (e.g., inventory levels, safety stock quantities, OTIF). In some implementations, the set of attributes displayed in the table are configurable and re-configurable by a user. For example, a user may select to display only a subset of available attributes that are pertinent to the user's analysis. Display region 306 can include summary information of key metrics for the set of searched/filtered facility items. For example, the display region 306 can show aggregated inventory levels, average OTIF, and aggregated values of other metrics for the facility items returned in response to the user's search/filter. In some implementations, the user's selection of a facility item (202) can be made by selecting an individual row in the table within display region 308.

In some implementations, responsive to the user's selection of the facility item (202), the client updates the user interface by replacing the current view (e.g., view 300a of FIG. 3A) with a new view (e.g., view 300b of FIG. 3B) that shows detailed information about the selected facility item (204). The detailed view 300b can include a range of information about the selected facility item, and typically includes more information and/or information at a greater level of granularity about the selected facility item than what is displayed in a summary view of the facility item or within the table shown in view 300a. In the example depicted in FIG. 3A, the detailed view of the selected facility item is a trends view that shows historical and projected trends in the values of one or more metrics for the facility item. The trends are represented in view 300b by a trends plot 316. The trends plot 316 can include bar graphs, line charts, and/or other plotted representations of the metrics for the facility item over an interval of time. In some implementations, view 300b of the user interface includes user-selectable controls that allow a user to adjust the time interval of trends plot 316.

Trends view 300b maintains display of the header region 302 from view 300a, thereby providing a degree of continuity between these two views 300a, 300b. View 300b further includes an overview display region 310 and a details display region 312. Overview display region 310 presents a summary of key information about the selected facility item. This information can include, for example, a material ID (e.g., a unique identifier of the particular facility represented by the facility item), a facility ID (e.g., a unique identifier of the particular facility that processes the selected item), indications of the business group and profit center assigned to the facility item, and values of one or more supply chain metrics for the facility item (e.g., inventory levels, OTIF, product availability).

While in the trends view 300b, the details display region 312 shows trends plot 316 over the specified time interval. Additionally, region 312 includes a set of user interface elements 314a-g in the form of buttons that can be selected by a user to immediately transition to different views of the user interface that show either different modes of information for the currently selected (focused) facility item or that pertain to a related (but different) facility item.

Selection of trends button 314a prompts the client device to render a trends view (e.g., view 300b) for the facility item that was selected by the user or that otherwise has current focus. Selection of BP charts button 314b prompts the client to render a line graph of a selected metric according to business-defined control limits.

Selection of product flow button 314c prompts the client device to render a product flow view of the user interface like the views 300c and 300d shown in FIGS. 3C-3D for the facility item that was selected by the user or that otherwise has current focus. Additional detail concerning product flow views is described further below.

Selection of upstream button 314d prompts the client device to render a detailed view (e.g., trends view) of the user interface for an upstream facility item, i.e., a facility item that is upstream of the facility item that was selected by the user or that otherwise has current focus. Selection of downstream button 314e prompts the client device to render a detailed view (e.g., trends view) of the user interface for a downstream facility item, i.e., a facility item that is downstream of the facility item that was selected by the user or that otherwise has current focus. The upstream and downstream buttons 314e-314d can thus be used to quickly transition to views of the user interface pertaining to a related (i.e., upstream or downstream) facility item without the user needing to manually identify the related item or needing to click through several screens as if he or she were locating the item in the first instance. When more than one upstream or downstream items exist, the system may prompt the user to select one of the options, or the system may automatically select one of the items based on criteria such as geographic proximity to the facility represented by the currently focused facility item or the amount of inventory supplied to or from the related facility for the product or material represented by the currently focused facility item. Additional detail regarding upstream and downstream relationships is described with respect to FIGS. 3C-3D.

Selection of focus upstream button 314f shifts focus to the next facility item upstream of the currently focused facility item. The next facility item upstream of the currently focused facility item can be the same supply chain item (e.g., product or material) as that represented by the currently focused facility item, except that the upstream facility item pertains to an upstream facility's processing of that same supply chain item. The upstream facility may be a supplier of the facility corresponding to the currently focused facility item. When more than one upstream facility exists, the system may prompt the user to select one of the facilities, or the system may automatically select one of the facilities based on criteria such as geographic proximity to the currently focused facility or the amount of the supply chain item supplied by each of the candidate upstream facilities to the currently focused facility. Applying focus to a facility item causes the system to perform certain operations with respect to that facility item rather than others. For example, the user may use trends button 314a and product flow button 314c to toggle between trends and product flow views of the currently focused facility item. When the focus upstream button 314f is selected from the trends view of the currently focused facility item, the client may either update the trends view to show trends for the upstream facility item or may render a product flow view for the upstream facility item. When the focus upstream button 314f is selected from the product flow view of the currently focused facility item, the newly focused upstream facility can be visually designated as such on the flow map without changing from the product flow view.

Selection of focus downstream button 314g shifts focus to the next facility item downstream of the currently focused facility item. The next facility item downstream of the currently focused facility item can be the same supply chain item (e.g., product or material) as that represented by the currently focused facility item, except that the downstream facility item pertains to a downstream facility's processing of that same supply chain item. The downstream facility may be supplied by the facility corresponding to the currently focused facility item. When more than one downstream facility exists, the system may prompt the user to select one of the facilities, or the system may automatically select one of the facilities based on criteria such as geographic proximity to the currently focused facility or the amount of the supply chain item supplied to each of the candidate downstream facilities from the currently focused facility. When the focus downstream button 314g is selected from the trends view of the currently focused facility item, the client may either update the trends view to show trends for the downstream facility item or may render a product flow view for the downstream facility item. When the focus downstream button 314g is selected from the product flow view of the currently focused facility item, the newly focused downstream facility can be visually designated as such on the flow map without changing from the product flow view.

With reference to the process 200 of FIG. 2, after rendering the detailed view (e.g., trends view 300b) of the user interface for the selected facility item, the client device receives an indication that the user has selected a flow-map control (e.g., product flow button 314c) (208). In response to selection of the flow-map control, one or more flow paths for the facility item are determined (208) and a product flow view for the selected facility item is rendered for display to the end user (210). Determination of the flow path can be performed by the client device, server (e.g., central system 102), or determined in part by both. A product (item) flow path is a description of the flow of a particular item in a supply chain between two or more facilities. The flow path of a selected facility item (or facility item that otherwise has focus) describes downstream flow, upstream flow, or both of the product represented by the selected facility item in relation to the facility represented by the selected facility item. For example, consider an item that is manufactured at a plant in Mankato, Minn., supplied to a distribution center in Louisville, Ky., and then shipped to a retailer in Cincinnati, Ohio. The flow path for this item originates in Mankato, and flows to Cincinnati via Louisville. If focus were applied to the Louisville facility, then an upstream segment of the flow path would be represented by a directed link from the Mankato to the Louisville facility, and a downstream segment of the flow path would be represented by a directed link from the Louisville to the Cincinnati facility. In some cases, more than one downstream and/or upstream segments may exist. Moreover, a given facility item may have multiple upstream suppliers and/or may supply multiple downstream facilities. In such cases, product flow paths may extend through each branch.

FIGS. 3C-3D depict screenshots of product flow views 300c and 300d for a selected facility item. These figures illustrate the rendering of an example flow path on a map consistent with operation 210 from FIG. 2. Product flow view 300c maintains header display region 302 and overview display region 310 from trends view 300b. However, the content of region 312 has changed from providing a trends plot 316 to providing a product flow map 318 for the facility item that was initially selected by the user (or that otherwise has current focus). In this example, a facility in Chicago, Ill. has current focus since the selected facility item relates to that facility's processing of ‘Widget XY.’ The flow map 318 includes an upstream segment that indicates the Chicago facility is supplied ‘Widget XY’ from an upstream facility in Europe. Flow map 318 further includes a first-order downstream segment indicating that the Chicago facility supplies ‘Widget XY’ to a downstream facility in Columbia, Mo., and a second-order downstream segment indicating that the Columbia facility supplies ‘Widget XY’ to a downstream facility in Minneapolis, Minn. Each of these facilities in the flow path is represented on the map by visual markers 320a-d overlaid at locations on the map that correspond to their geographic locations in the real world. Arrows showing the direction of flow of the item connect the facilities on the map 318. In some implementations, the facility item that has current focus can be visually emphasized relative to other facilities that do not have focus. For example, visual marker 320b for the Chicago facility is represented in a different color than the other markers 320a, 320c-d in FIG. 3C. This visual emphasis can change to a different marker if a user selects to apply focus to a downstream or upstream facility. The visual markers 320a-d can take a variety of forms such as pins, icons, graphics, text, or a combination of these. In some implementations, a user can interact with visual markers 320a-d. When the user hovers a pointer over and/or clicks on a visual marker for a particular facility on the flow map 318 to select that marker, focus can be automatically applied to the facility (and facility item) represented by the marker, a pop-up window can be displayed at or near the marker showing certain details about the facility or facility item represented by the marker, and/or the trends view can be rendered for the facility item represented by the marker. In some implementations, the user can pan the map 318 to view different geographic areas within the bounds of the viewport. The user may also interact with zoom control 322 to zoom into our out of the map 318 to a desired zoom level. For instance, view 300c shows a relatively zoomed-out view spanning much of North America and Europe. In contrast, view 300d shows the map 318 at a closer zoom level that isolates as a portion of the United States where three of the facility markers 320b-d are located. Both views 300c and 300d maintain buttons 314a-g within display region 312 to allow users to efficiently transition between display modes and quickly access information regarding upstream or downstream facility items.

Referring again to FIG. 2, boxes 212-232 show four alternate courses of action that may be taken by a user from a product-flow view (e.g., views 300c or 300d), in certain examples. Boxes 212-214 illustrate a first course of action, boxes 216-220 illustrate a second course, boxes 222-224 illustrate a third course, and boxes 226-232 illustrate a fourth course.

Starting from the product flow view (e.g., views 300c or 300d), in the first course of action, the client device receives an indication that a user selected a visual marker (e.g., marker 320b) on the flow map (e.g., map 318) for a facility in a depicted flow path (212). In response to selection of the visual marker, the client device renders a detailed view (e.g., trends view 300b) for the facility item or the facility corresponding to the selected marker (214).

Starting from the product flow view (e.g., views 300c or 300d), in the second course of action, the client device receives an indication that a user selected a detailed-view UI control (e.g., trends view button 314a) (216). In response, the client identifies the facility or facility item with current focus (218), and replaces the product flow view (e.g., view 300c or 300d) with a detailed view (e.g., trends view 300b) for the facility or facility item that has current focus in the system (220).

Starting from the product flow view (e.g., views 300c or 300d), in the third course of action, the client device receives an indication that a user instructed (e.g., via selection of buttons 314f or 314g) to shift focus to another facility upstream or downstream of the currently focused facility (222). In response, the client device applies focus to the next upstream or downstream facility, according to the user's instruction (224).

Starting from the product flow view (e.g., views 300c or 300d), in the fourth course of action, the client device receives an indication that a user selected an upstream or downstream detailed view control (e.g., buttons 314d or 314e) (226). In response, the client device identifies the facility that has current focus (228), identifies a second facility having an upstream or downstream relationship to the facility with current focus (230), and renders a detailed view (e.g., trends view 300b) for the second facility in the user interface (232). The detailed view for the second facility can specifically pertain to the same product or supply chain item as the facility item that was previously the object of focus, or the detailed view for the second facility can more broadly present information related to the second facility's processing of a range of items.

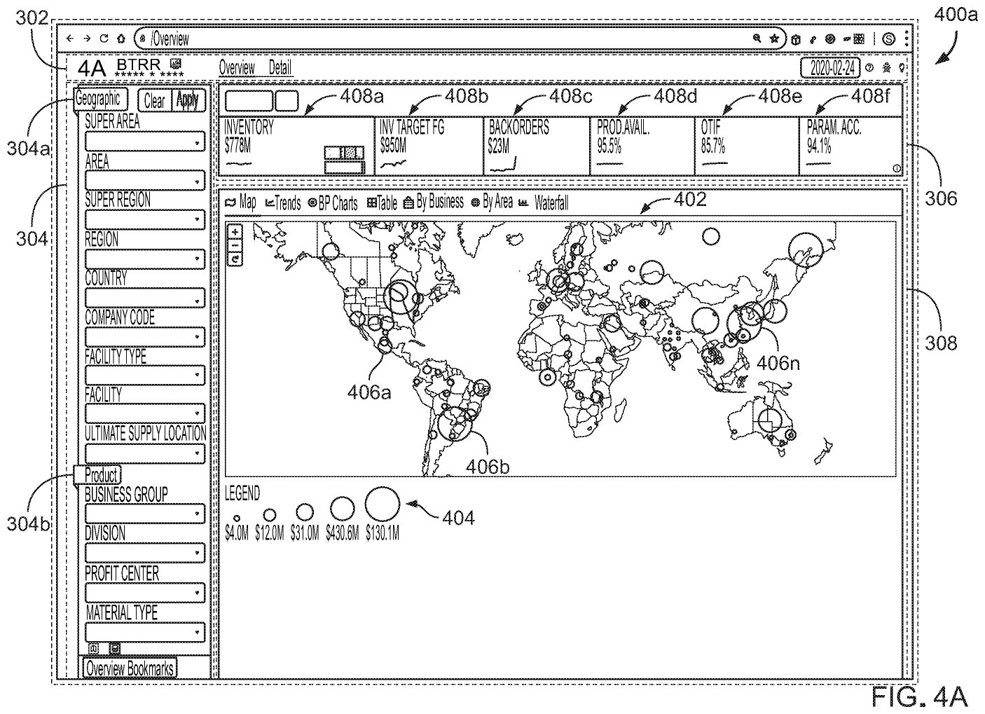

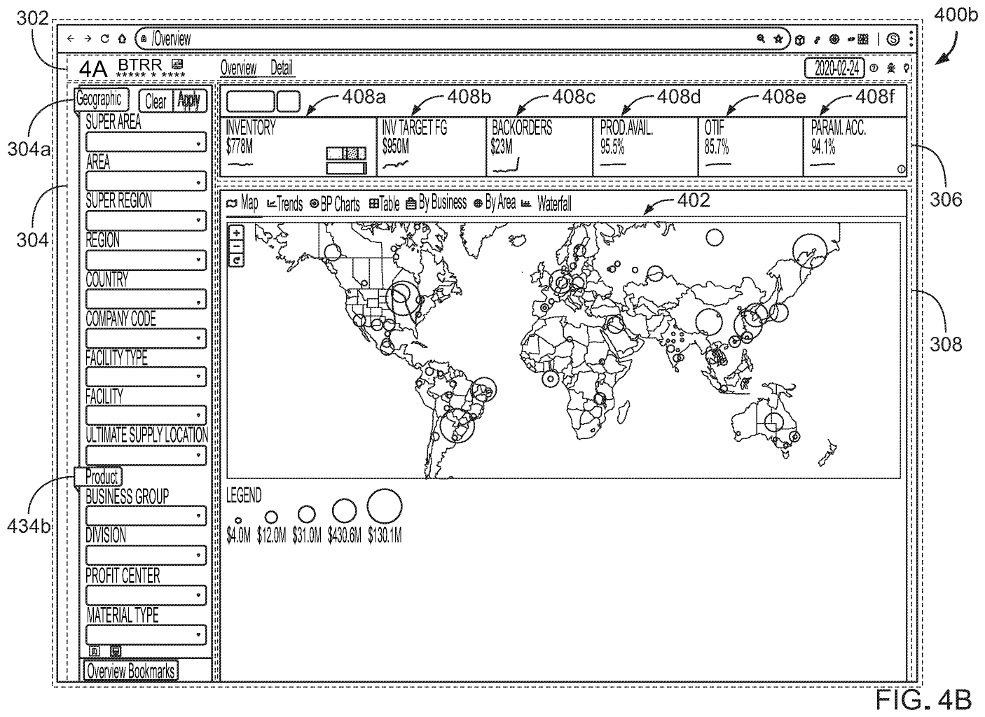

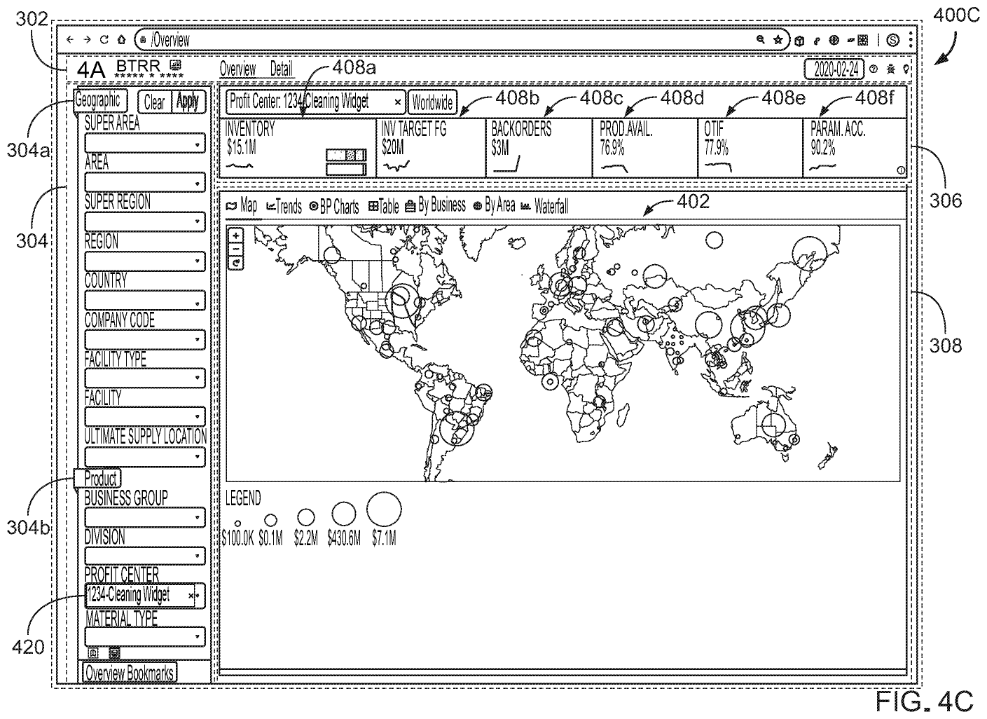

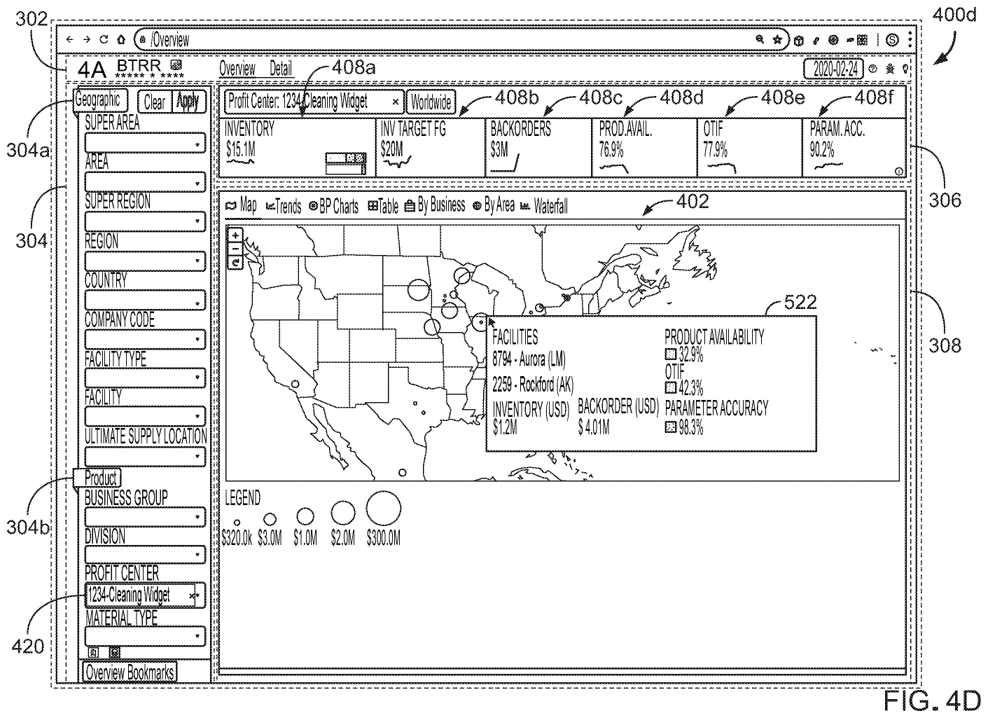

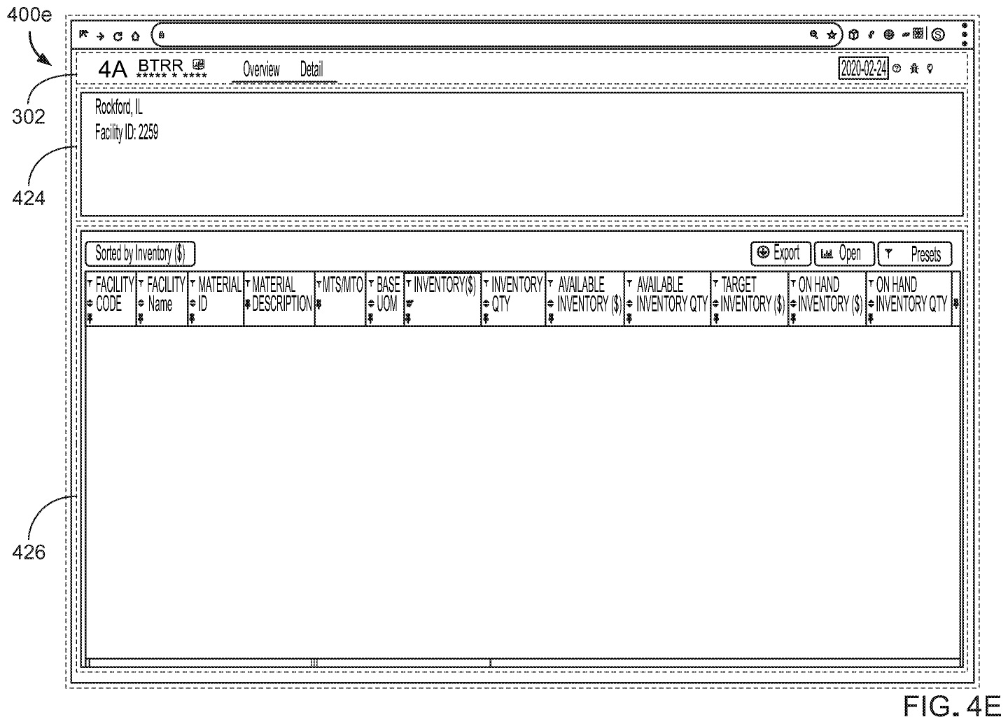

FIGS. 4A-4E depict screenshots of additional views of the user interface that allow users to efficiently access and visualize information about facilities in a supply chain. In some implementations, a same client device application that rendered the screenshots shown in FIGS. 3A-3D can further be configured to generate the views shown in FIGS. 4A-4E. A client device, e.g., any of client computing systems 116a-n, can run the client device application to render the views shown in FIGS. 4A-4E. To start, a first view 400a of the user interface is shown in FIG. 4A. View 400a includes display regions 302, 304, 306, and 308. Region 302 can include header information like the headers provided in views 300a-300d. Region 304 includes search and filtering tools that allow a user to specify geographic and/or product criteria for a target set of facilities that are of interest to the user. Region 306 provides an overview of facility information for the target set of facilities (i.e., facilities that meet the user's search/filtering criteria). In some implementations, if no search or filtering criteria are specified, the target set of facilities includes all registered facilities in the supply chain. Region 306 includes a set of user interface elements 408a-408f that each correspond to different supply chain metrics such as actual inventory amount in dollars, target inventory level, backorders amount in dollars, product availability percentage, OTIF percentage, and parameter accuracy percentage. Elements 408a-f can show computed aggregates of the values for their corresponding metrics across all facilities in the target set of facilities. For instance, the total inventory amount across the target facilities in view 400a is shown on element 408a, and the average OTIF percentage across target facilities is shown on element 408e. Furthermore, elements 408a-f can be buttons or other user-selectable elements that, when selected, prompt the client application to update the display of the facility map 402 so that visual markers for the target set of facilities indicate values of the corresponding metric for the selected element.

Display region 308 includes a facility map 402 and a map legend 404. Facility map 402 comprises a map of a geographic area overlaid with visual markers 406a-n that represent individual facilities or groups of proximally located facilities in a supply chain. Each facility within the target set of facilities can be represented by a visual marker, while facilities not within the target set are typically not marked on the map 402. The visual marker 406 for an individual facility can be formatted in a manner that visually represents the value of the selected supply chain metric. For instance, as shown in FIG. 4A, the visual markers 406a-n have a circular shape centered at a location on the map corresponding to the geographic location of the represented facility. The size of the circle corresponds to the value of the selected supply chain metric, such as the amount of inventory stored at the facility when inventory level is the selected supply chain metric. In some implementations, two or more attributes of the visual markers 406a-n can be adjusted to represent values of additional metrics when more than one metric is selected. For example, the circular markers may be sized according to inventory amount and colored according to OTIF percentage. In some implementations, visual markers 406a-n can be colored based on the selected supply chain metric. For instance, blue circles may indicate that the selected metric is inventory amount while black circles indicate that the selected metric is OTIF percentage.

Geographic filtering can geographically limit the set of facilities displayed on the map 402. Product filtering can also limit the set of target facilities by restricting to only those facilities that process items that match the product criteria. Additionally, product filtering can impact the values of the metrics conveyed to the user for each facility. Rather than aggregating the values of all items processed by the facilities, the client device application may aggregate the values of only those items matching the product filtering criteria. The aggregated values on the filtered set can then be displayed by UI elements 408a-f and represented by visual markers 406a-n.

In some implementations, multiple facilities may be located in close geographic proximity of each other. Several warehouses, for example, may be constructed adjacent to each other on a large piece of real estate. Rendering separate visual markers on a facility map for each proximately located facility may be impractical because it may be difficult for users to perceive or distinguish between the visual markers (especially where the map view is zoomed out to encompass a much larger area). Additionally, the provision of individual markers for each facility may clutter the display on the map. Accordingly, the client device application may be configured to identify groups of proximally located facilities, and to render over the facility map just a single visual marker for the group as a whole rather than individual markers for each facility in the group. In some implementations, attribute(s) such as size and color of the visual marker for a group of facilities can be set based on aggregated or averaged values of the selected metric(s) for the facilities in the group. For example, inventory levels may be aggregated across the facilities in a group, and the aggregated inventory level can be used to size the circular marker representing the group of facilities. The system can determine groups of proximally located facilities based on factors such as the distance between the facilities, the current zoom level of the facility map, the size or resolution of the facility map on the client device display, and the number of visual markers presented within all or a portion of the facility map.

In some implementations, the techniques for formatting visual markers of facilities as shown in FIGS. 4A-4E can be applied in a corresponding manner to the formatting of visual markers overlaid on the item flow maps depicted in FIGS. 3A-3D.

FIG. 4B depicts a second view 400b of the user interface. Like view 400a, view 400b depicts a facility map 402. However, in view 400b, UI element 408b has been selected, and the visual markers have been re-rendered on the map 402 to be sized according to the target inventory levels of the facilities (i.e., the metric associated with element 408b) rather than sized according to actual inventory levels (i.e., the metric associated with element 408a).

FIG. 4C depicts a third view 400c of the user interface. Here, the user has specified a product filter by restricting results to those related to products within a selected profit center. The target facilities are thus limited to facilities that process items within the selected profit center, and only these facilities are shown on the facility map 402.

FIG. 4D depicts a fourth view 400d of the user interface. Like view 400c, view 400d is filtered on the selected profit center. The user has also zoomed into a view of the United States. As shown, when the user hovers over or selects a visual marker, a pop-up window 422 appears near the selected visual marker that displays values of certain metrics for the facility. A description and identifier of the facility represented by the visual marker can also be presented in the pop-up window 422. When the visual marker represents a group of facilities, each facility in the group can be identified and listed in the pop-up window 422.

FIG. 4E depicts a fifth view 400e of the user interface. The client application may render the fifth view 400e upon a user's selection of a visual marker for a particular facility on the facility map 402 and/or upon a user's selection of an element within pop-up window 422. The fifth view 400e includes header display region 302, an overview display region 424, and an items display region 426. The overview display region 424 is configured to present values of metrics and other details about the selected facility (e.g., the Rockford, Ill. facility). The items display region 426 is configured to present a table listing items processed by the selected facility (and associated metrics and metadata for the listed items).

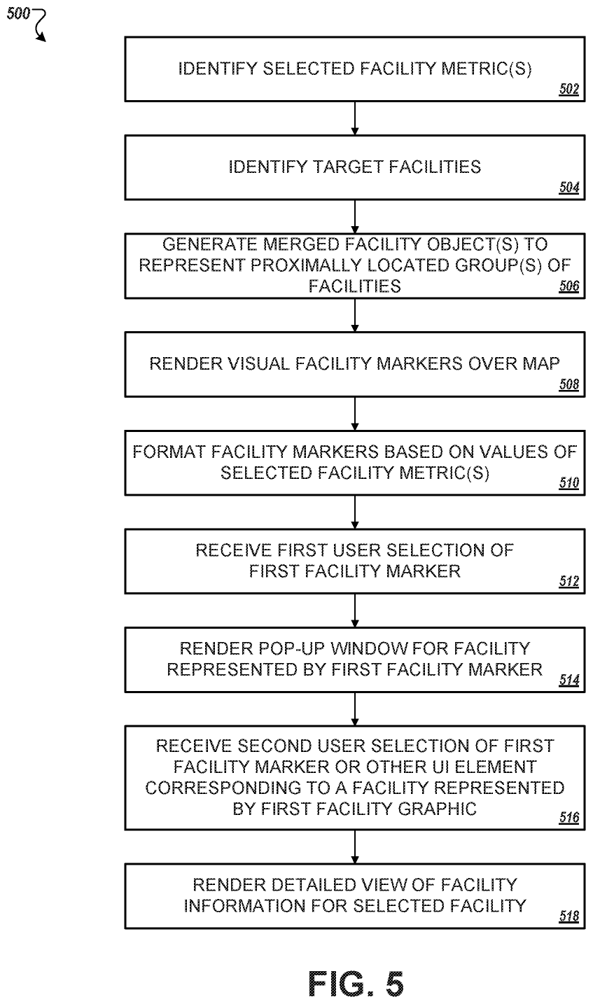

FIG. 5 is a flowchart of an example process 500 for rendering facility maps in a user interface. Process 500 can be performed by the front-end of a supply chain management system, e.g., system 100 of FIG. 1. In some implementations, process 500 is performed by a client device of an end user, e.g., any of client computing systems 116a-n of FIG. 1. The client device identifies one or more facility metrics selected by a user (502). The client device also determines a set of target facilities, e.g., based on comparison of search or filtering criteria from a user with geographic and/or product attributes of facilities registered with the system (504). In some cases, the client device determines one or more groups of proximally located facilities and creates merged (composite) facility object to represent the groups (506). Visual markers for the non-proximally located facilities and the merged facilities are rendered over a map of a geographic area (i.e., a facility map) (508). The client device can format visual attributes of the markers according to the values of the selected metric(s) associated with the facilities (510). A user may also interact with the facility map and select the visual marker for a particular facility of interest (512). In response, the client device may render a pop-up window (e.g., window 422) in the vicinity of the visual marker that shows additional information about the facility (514). The user may select the visual marker for the facility a second time or in a different fashion, or may select another UI element presented alongside the facility map (516), and in response the client device renders a detailed view (e.g., view 400e) of information about the selected facility (518).

Embodiments of the subject matter described in this specification can be implemented in a computing system that includes a back-end component, e.g., a data server, a middleware component, e.g., an application server, and/or a front-end component, e.g., a client computer or client device. The components of the system can be interconnected by any form or medium of digital data communication, e.g., a communication network. Examples of communication networks include a local area network (LAN) and a wide area network (WAN), e.g., the Internet.

The computing system can include client computing systems and servers. A client device and server are typically located a substantial distance from each other, but are configured to interact through a communication network. The relationship of a client devices and server can arise by virtue of computer programs running on the respective computers and having a client-server relationship to each other. In some implementations, a server transmits data, e.g., an HTML page, to a user device, e.g., for purposes of displaying data to and receiving user input from a user interacting with the user device, which acts as a client device. Data generated at the user device (client device), e.g., a result of the user interaction, can be received from the user device at the server.

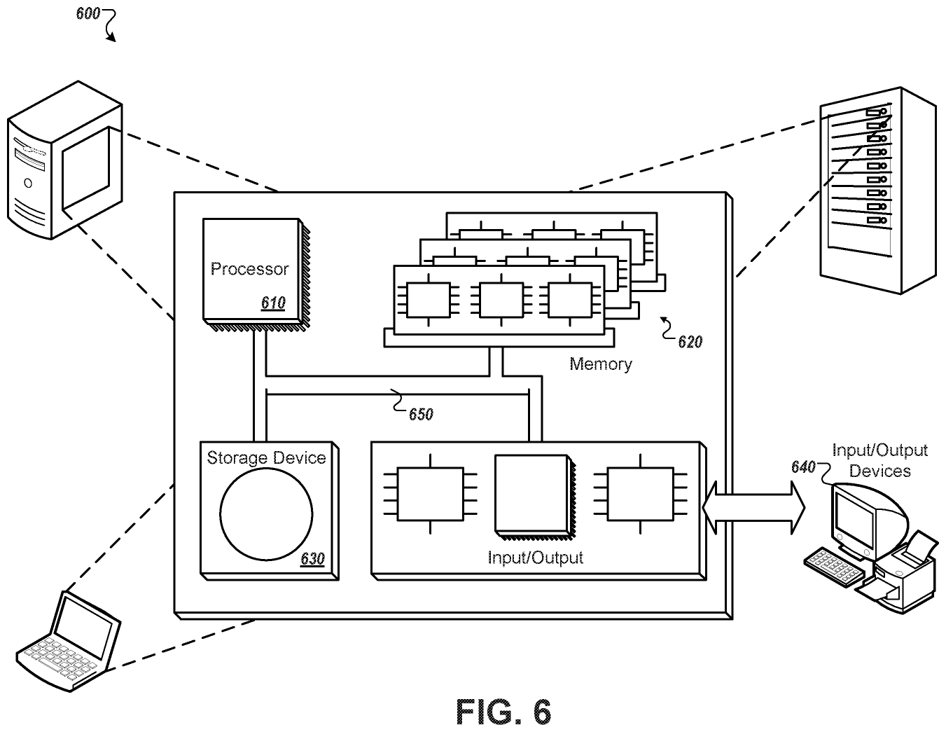

An example of one such type of computer is shown in FIG. 6, which depicts a schematic diagram of a generic computer system 600. The system can be used for the operations described in association with any of the computer-implemented methods described in this specification. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims.

What is claimed is:

1. A computer-implemented method, comprising:
receiving, by a computing system, an indication of a selected facility item, wherein the selected facility item represents a particular supply chain item that is processed at a particular facility of a plurality of facilities in an organization;
rendering, by the computing system for display on a screen of the computing system, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receiving, by the computing system, a selection of a first user interface element within the first view of the user interface; and
in response to receiving the selection of the first user interface element within the first view of the user interface, transitioning from the first view of the user interface that includes the item flow map to a second view of the user interface that shows additional information pertaining to the selected facility item or the particular facility represented by the selected facility item that is not shown in the first view.

2. The method of claim 1, wherein receiving the indication of the selected facility item comprises receiving (i) an item identifier that uniquely represents the particular supply chain item and (ii) a facility identifier that uniquely represents the particular facility.

3. The method of claim 1, wherein the first user interface element is a button that is available for selection by a user when in the first view of the user interface and when in the second view of the user interface.

4. The method of claim 1, wherein transitioning from the first view of the user interface to the second view of the user interface comprises replacing a display of the item flow map with at least one other user interface element so that the item flow map is no longer displayed in the user interface, the at least one other user interface element showing the additional information pertaining to the selected facility item or the particular facility represented by the selected facility item.

5. The method of claim 1, wherein transitioning from the first view of the user interface to the second view of the user interface comprises transitioning to a view that shows additional information pertaining to the selected facility item that is not shown in the first view, wherein the additional information comprises values of one or more metrics related to the particular facility's processing of the particular supply chain item.

6. The method of claim 5, wherein the one or more metrics related to the particular facility's processing of the particular supply chain item are selected from a group comprising a monetary value of inventory of the particular supply chain item at the particular facility, a quantity of the particular supply chain item at the particular facility, a target level of inventory of the particular supply chain item at the particular facility, a level of backorders of the particular supply chain item at the particular facility, and a percentage of on-time and in-full (OTIF) deliveries of the particular supply chain item made from the particular facility.

7. The method of claim 1, wherein transitioning from the first view of the user interface to the second view of the user interface comprises bringing up a plot showing values of one or more metrics related to the particular facility's processing of the particular supply chain item over an interval of time.

8. The method of claim 7, wherein the interval of time is adjustable based on user input.

9. The method of claim 1, further comprising receiving, within the second view of the user interface, a selection of the first user interface element or a second user interface element, and in response, transitioning from the second view of the user interface to the first view of the user interface that includes the item flow map.

10. The method of claim 1, further comprising, receiving, within the first view of the user interface or within the second view of the user interface, a selection of a second user interface element, and in response, transitioning from (i) the first view of the user interface pertaining to the selected facility item or (ii) the second view of the user interface pertaining to the selected facility item or the particular facility represented by the selected facility item, to a third view of the user interface pertaining to a second facility's processing of the particular supply chain item represented by the selected facility item, wherein the second facility is an upstream facility that supplies the particular supply chain item to the particular facility or a downstream facility is supplied the particular supply chain item from the particular facility.

11. The method of claim 1, wherein rendering the first view of the user interface comprises collecting data for the item flow map, including:
identifying the particular facility represented by the selected facility item;
identifying a second facility upstream of the particular facility that supplies the particular supply chain item to the particular facility;
identifying one or more third facilities other than the particular facility that are located downstream of the second facility such that the second facility supplies the one or more third facilities with the particular supply chain item; and
rendering visual markers on the item flow map corresponding to the particular facility, the second facility, and the one or more third facilities.

12. The method of claim 1, wherein the particular facility represented by the selected facility item initially has focus in the first view of the user interface; and
the method further comprises:
receiving, while the particular facility has focus, a selection of a second user interface element within a view of the user interface that pertains to the selected facility item;
in response to receiving the selection of the second user interface element, shifting focus from the particular facility to a second facility based on the second facility being upstream or downstream of the particular facility with respect to the particular supply chain item;
receiving a selection of the first user interface element or a third user interface element while the second facility has focus within the view of the user interface that pertains to the selected facility item; and
in response to receiving the selection of the first user interface element or the third user interface element while the second facility has focus within the view of the user interface that pertains to the selected facility item, transitioning from the view of the user interface that pertains to the selected facility item to a view of the user interface that pertains to the second facility.

13. The method of claim 12, wherein the view of the user interface that pertains to the second facility is a view that pertains to the second facility's processing of the particular supply chain item.

14. The method of claim 12, wherein the view of the user interface that pertains to the selected facility item is the first view of the user interface or the second view of the user interface.

15. The method of claim 12, wherein the second user interface element is a visual marker on the item flow map representing the second facility.

16. The method of claim 12, wherein the second user interface element is a control that is not specifically associated with any particular facility.

17. The method of claim 12, wherein the user interface is rendered in a web browser.

18. The method of claim 1, wherein the item flow map includes a background map of a geographic region and a plurality of visual markers overlaid on the background map, the plurality of visual markers including a first visual marker for the particular facility represented by the selected facility item, one or more second visual markers for one or more other facilities in the organization that also process the particular supply chain item represented by the selected facility item, and one or more third visual markers depicting the flow between the at least two facilities.

19. A computing system, comprising:
one or more processors; and
one or more non-transitory computer-readable media having instructions stored thereon that, when executed by the one or more processors, cause the one or more processors to perform operations comprising:
receiving, by the computing system, an indication of a selected facility item, wherein the selected facility item represents a particular supply chain item that is processed at a particular facility of a plurality of facilities in an organization;
rendering, by the computing system for display on a screen of the computing system, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receiving, by the computing system, a selection of a first user interface element within the first view of the user interface; and
in response to receiving the selection of the first user interface element within the first view of the user interface, transitioning from the first view of the user interface that includes the item flow map to a second view of the user interface that shows additional information pertaining to the selected facility item or the particular facility represented by the selected facility item that is not shown in the first view.

20. One or more non-transitory computer-readable media having instructions stored thereon that, when executed by one or more processors, cause the one or more processors to perform operations comprising:
receiving, by a computing system, an indication of a selected facility item, wherein the selected facility item represents a particular supply chain item that is processed at a particular facility of a plurality of facilities in an organization;
rendering, by the computing system for display on a screen of the computing system, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receiving, by the computing system, a selection of a first user interface element within the first view of the user interface; and
in response to receiving the selection of the first user interface element within the first view of the user interface, transitioning from the first view of the user interface that includes the item flow map to a second view of the user interface that shows additional information pertaining to the selected facility item or the particular facility represented by the selected facility item that is not shown in the first view.
